(19) United States
(12) Patent Application Publication
(10) Pub. No.: US 2010/0130154 A1
(43) Pub. Date: May 27, 2010

(54) AMPLIFICATION SYSTEM FOR INTERFERENCE SUPPRESSION IN WIRELESS COMMUNICATIONS

(76) Inventors: Sei-Joo Jang, Seoul (KR); Haengseob Kim, Seoul (KR); Donghyun Yoo, Seoul (KR)

Correspondence Address: JOHN J. ELNITSKI, JR., 225 A SNOWBIRD LANE, BELLEFONTE, PA, 16823, US

(21) Appl. No.: 12/362,919

(22) Filed: Jan. 30, 2009

(30) Foreign Application Priority Data
Nov. 24, 2008 (KR) 10-2008-0116908
Nov. 24, 2008 (KR) 10-2008-0116929

(51) Int. Cl. H04B 1/06

(52) U.S. Cl. 455/253.2

(57) ABSTRACT

An amplification system including a high gain amplifier, filter module and low gain amplifier. The high gain amplifier for receiving an input RF signal and processing the input RF signal to produce a first amplified signal while the high gain amplifier is operating near its saturation point. The filter module having at least one band pass filter to receive the first amplified signal and process the first amplified signal to remove unwanted characteristics of the first amplified signal to produce a processed first amplified signal. The low gain amplifier receiving the processed first amplified signal and processing the processed first amplified signal to produce a second amplified signal that has an increase in signal strength over the processed first amplified signal while the low gain amplifier is operating near its saturation point.

This application claims the benefit under Title 35, United States Code, Section 119 and incorporates by reference Korean applications 10-2008-0116908, filed Nov. 24, 2008 and 10-2008-0116929, filed Nov. 24, 2008.

### BACKGROUND

The present invention generally relates to amplification of wireless signals in communication equipment. More specifically, the present invention relates to amplification of wireless signals efficiently.

Mobile telecommunication networks employ stationary communication units such as base stations and repeaters to allow communications between wireless devices, such as cell phones and other devices. The repeaters are used between the base station and the wireless devices to enhance the quality of the RF signal, extend service area around the base stations and reduce the cost of the network. The output power of a base station is as large as several hundred Watts. The average output power of a repeater varies from a few Watts to about sixty Watts. However, the power output efficiency of equipment in stationary communication units is notoriously “low”, at only a little better than ten percent. The output RF power efficiency for the purposes of the present invention is defined as: total RF radiation power of the stationary communication unit divided by DC electric power required by an output power amplifier (PA) of the stationary communication unit in order to generate that total RF radiation power. So for a stationary communication unit having a power output efficiency of ten percent, about 200 Watts of DC power at the output power amplifier is required to radiate a useful 20 Watts RF power signal to the open space through an antenna. The remaining 180 Watts of the 200 Watts of DC power is lost as heat, which should be removed quickly for the stability of the system. To maintain stable equipment operation, the excess heat generated by this loss usually requires a heat sinking passive panel, as well as an active fan and air or water cooling devices to remove the heat from the system.

FIG. 1 shows a schematic of a typical RF power amplification system used in current stationary communication units. There is input RF signal to be amplified. The input RF signal is inputted at point (a) to a Driving Amplifier (DA). The output of the DA is a first amplified version of the RF signal that was inputted to the DA. The output of the DA is then inputted to an output power amplifier (PA) at point (c). The output of the PA is a second amplified version of the RF signal that was inputted to the DA and which is outputted to open space at point (d) to via an antenna (ANT). In the current amplification systems of FIG. 1, the input RF signal is amplified less at the DA, than at the PA, and the greater amplification is performed at the PA.

One of the reasons for such low power efficiency of mobile telecommunication equipment is that the quality of RF signal radiated to an open space needs to be extremely high. This requirement of a high quality signal is necessary for preventing interference among signals from different service providers in common open space, as required by laws in many countries. Among several characteristics in the radiation of a RF, Adjacent Channel Leakage Power Ratio (ACLR) is one of the most important characteristics to be considered to prevent interference among RF signals from different service providers. The optimum efficiency of the PA can be obtained, in general, when the PA is operating at near its saturation point. Most PA exhibit some degree of nonlinearity near their saturation point, which causes an increase in the spectral growth of the output power density and leads to distortion of the ACLR of the output signal. Therefore, current PAs employed in typical amplification systems are designed to operate within a linear region prior to the saturation point of the PA to satisfy the ACLR requirement and therefore sacrifice efficient operation of the PA.

FIG. 2 shows a single channel power spectral density graphical representation using a typically system of the class related to current amplification systems that are depicted in FIG. 1. Using the properties of isolation and sharp skirt together, the ACLR can be expressed graphically in output signal power spectrum density readouts, as shown in FIG. 2. FIG. 3 shows a power spectral density graphical representation of a full band WIBRO RF signal at point (a) depicted in FIG. 1. FIG. 4 shows a power spectral density graphical representation of the full band WIBRO RF signal of FIG. 3 at point (c) depicted in FIG. 1. FIG. 5 shows a power spectral density graphical representation of a twenty Watts full band WIBRO output RF signal at point (d) depicted in FIG. 1. The ACLR for a twenty Watt full band WIBRO output RF signal of FIG. 5 shows about −29 dBc, which does not meet the current ACLR requirements of equal or better than −37 dBc. A PA used in the output power amplification systems of FIG. 1 has to operate at its linear region with the lower output power efficiency in order to meet the required ACLR of −37 dBc or better. Consequently, an output RF signal strength of full band WIBRO of FIG. 1, would be much smaller than twenty Watts with much lower output power efficiency.

In general, the efficiency of a RF power amplifier transistor is better than twenty five percent. It is reported that an efficiency of even close to fifty percent with a gain of 8 db to 20 db is available for newly developed power amplifier transistors. The quality of the final output signal is not only dependent on the characteristics of PA of FIG. 1, but is affected strongly by the quality of the input RF signal to the PA. Whereby, both the in-band RF signal and out-band noise are amplified at PA. Usually the gain of the PA is between 30 dB to 50 dB. This means that a magnitude of 0 dBm input signal is required to generate a 30 to 50 dBm output signal. However, the out-band noise is also amplified by 30 dB to 50 dB to produce out-band noise in the range of −20 dBm or higher, which is not a very desirable situation in terms of maintaining the required ACLR characteristics when producing an amplified RF output signal.

If the RF power efficiency of a base station or repeater could be raised from ten percent to twenty percent for an example, the benefits would not only be from the savings of electric energy cost, but also from the savings of manufacturing, installation, maintaining, and durability of the equipment due to their simpler, lighter, and smaller configuration compared to those used in current systems. It is very desirable to enhance the efficiency of generating a high quality useful RF radiation signal in the mobile telecommunication equipment. The mobile WIMAX, WIBRO and fourth generation mobile telecommunication networks, such as the LTE (Long Term Evolution), are planned for 2009 and beyond in the United States, as well as other parts of world. The output power levels for the planned network equipment are quite high, from fifty Watts to a few hundred Watts. It is clear that higher efficiency power equipment will desirable to be employed with the larger output RF power equipment. The demand for high efficient RF output power of the mobile telecommunication equipment for base stations and repeaters is on the increase. It would be a big step forward to improve the efficiency of mobile telecommunication equipment by finding a relatively simple way to enhance the efficiency of the output power amplifier in the stationary comm units to enhance whole networks including the mobile WIMAX, WIBRO and the up coming the fourth generation systems such as the LTE. It is worthwhile try to understand why the efficiency of output power amplifiers in mobile communication equipment is so low.

It is an object of the present invention to provide an amplification system for wireless communications that operates near optimum efficiency while suppressing interference.

### SUMMARY OF THE INVENTION

An amplification system including a high gain amplifier, filter module and low gain amplifier. The high gain amplifier for receiving an input RF signal and processing the input RF signal to produce a first amplified signal while the high gain amplifier is operating near its saturation point. The filter module having at least one band pass filter to receive the first amplified signal and process the first amplified signal to remove unwanted characteristics of the first amplified signal to produce a processed first amplified signal. The low gain amplifier receiving the processed first amplified signal and processing the processed first amplified signal to produce a second amplified signal that has an increase in signal strength over the processed first amplified signal while the low gain amplifier is operating near its saturation point.

### BRIEF DESCRIPTION OF DRAWINGS

FIG. 1 is a schematic view of a typical amplification system in the prior art.

FIG. 2 is a graphical data representation of output power spectral density according to the present invention.

FIG. 3 is a graphical data representation of a signal at the position (a) of FIG. 1 according to the present invention.

FIG. 4 is a graphical data representation of a signal at the position (c) of FIG. 1 according to the present invention.

FIG. 5 is a graphical data representation of a twenty Watt output signal at the position (d) of FIG. 1 according to the present invention.

FIG. 6 is a schematic view of an amplification system according to the present invention.

FIG. 7 is a graphical data representation of a signal at the position (a′) of FIG. 6 according to the present invention.

FIG. 8 is a graphical data representation of a signal at the position (b′) of FIG. 6 according to the present invention.

FIG. 9 is a graphical data representation of a signal at the position (c′) of FIG. 6 according to the present invention.

FIG. 10 is a graphical representation of characteristics of a RF band pass filter according to the present invention.

FIG. 11 is a schematic view of two band pass filters connected in series according to the present invention.

FIG. 12 is a graphical representation of characteristics of two RF band pass filters connected in series according to the present invention.

FIG. 13 is a schematic view of two band pass filters connected in series according to the present invention.

FIG. 14 a schematic view of a plurality of band pass filters connected in series according to the present invention.

FIG. 15 is a graphical representation of the ideal response according to the present invention.

FIG. 16 is a graphical data representation of a 20 W output signal at the position (d′) of FIG. 6 according to the present invention.

FIG. 17 is a table of experimental data according to the present invention.

FIG. 18 is a schematic view of WIBRO repeater with the amplification system according to the present invention.

FIG. 19 is a representation of principles of pre-distorter linearization according to the present invention.

FIG. 20 is a schematic view of DPD according to the present invention.

FIG. 21 is a schematic view of DPD with the amplification system according to the present invention.

### DETAILED DESCRIPTION

The present invention is an amplification system to suppress interference in mobile telecommunication equipment, while increasing RF power output efficiency. The present invention is also a method of implementing the suppression of interference in mobile telecommunication equipment, while increasing RF power output efficiency of the in mobile telecommunication equipment and maintaining the required ACLR. Whereby, RF power output efficiency is defined as: total RF radiation power of the stationary communication unit divided by DC electric power required by an output power amplifier of the stationary communication unit in order to generate that total RF radiation power. The amplification system of the present invention provides signal characteristics of a large isolation, sharp skirt, a good ripple, and acceptable S11 and S12 properties.

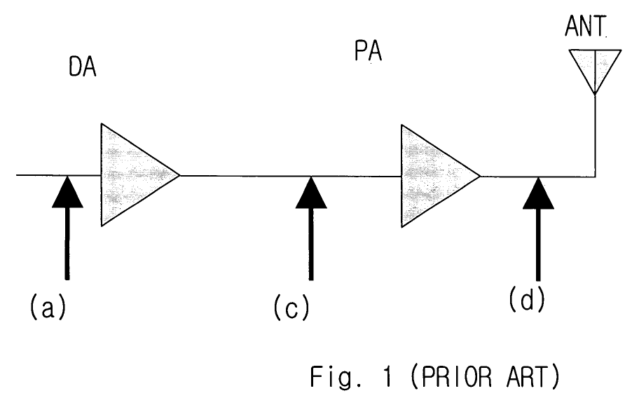

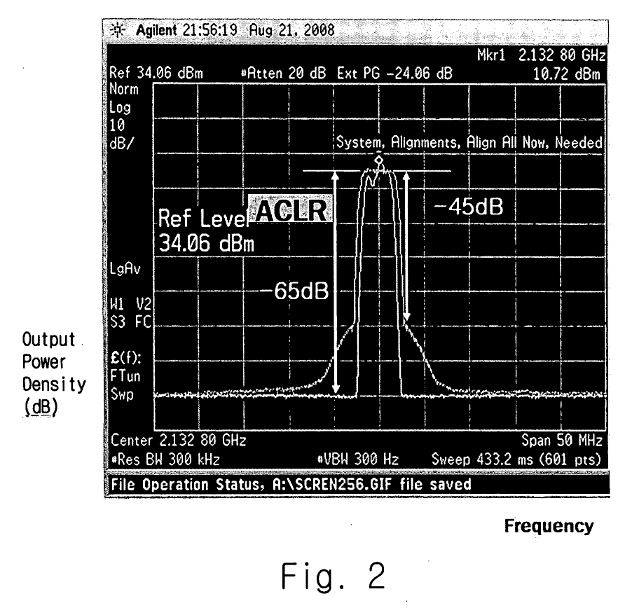

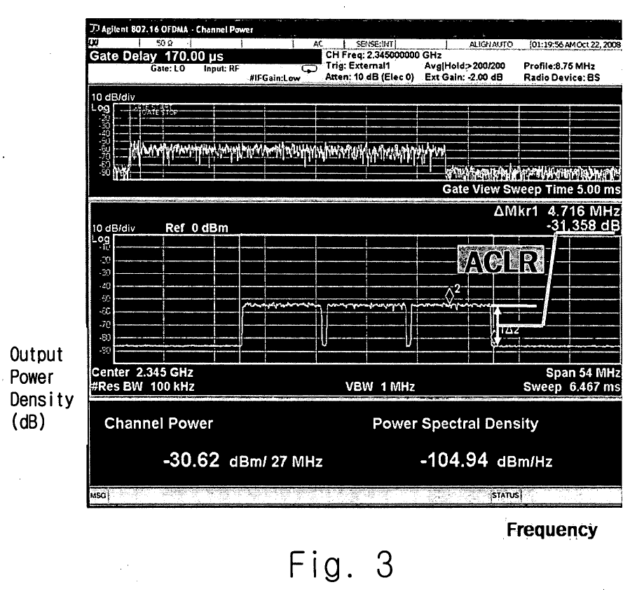

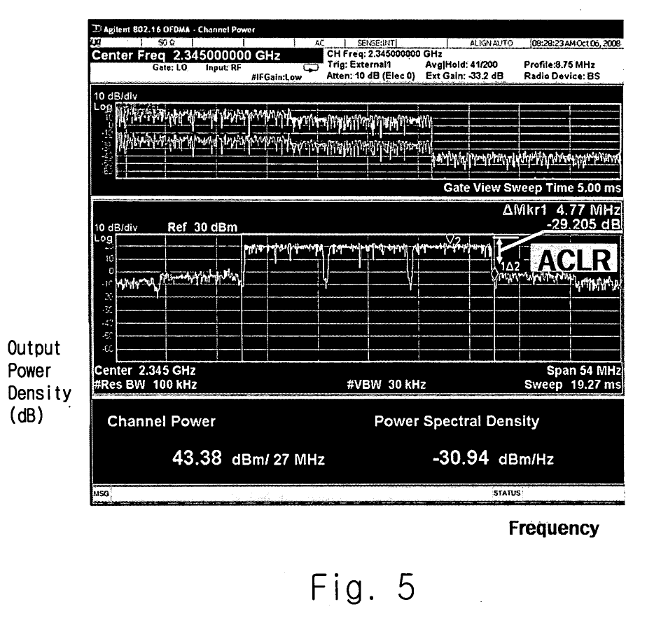

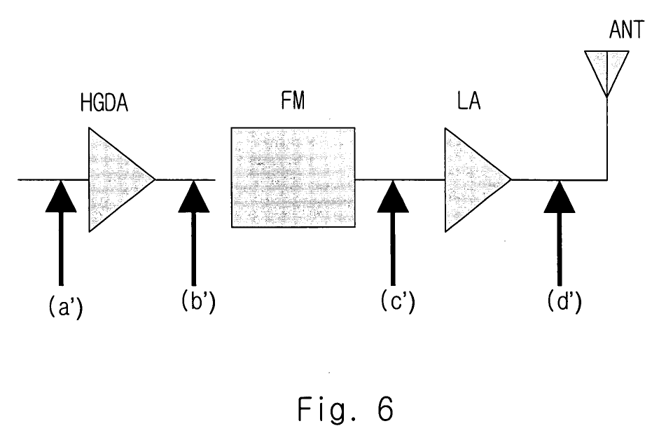

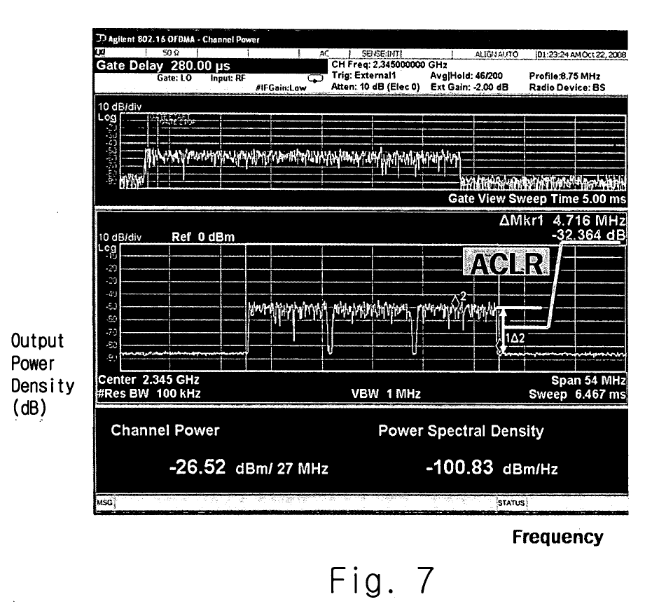

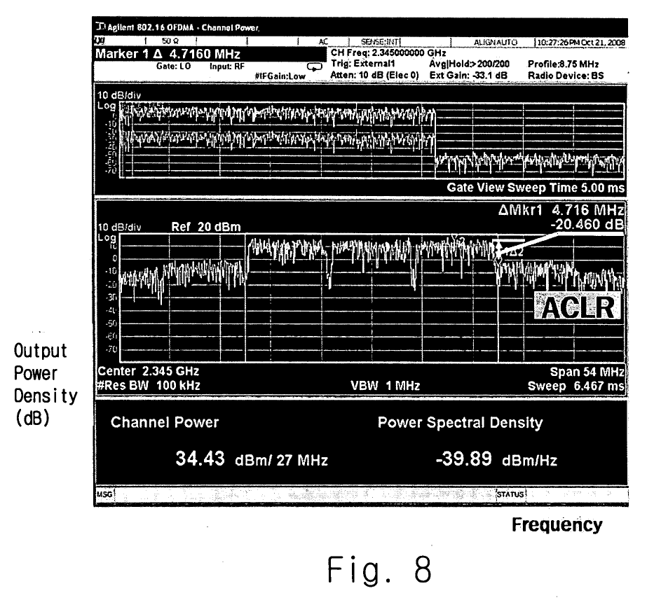

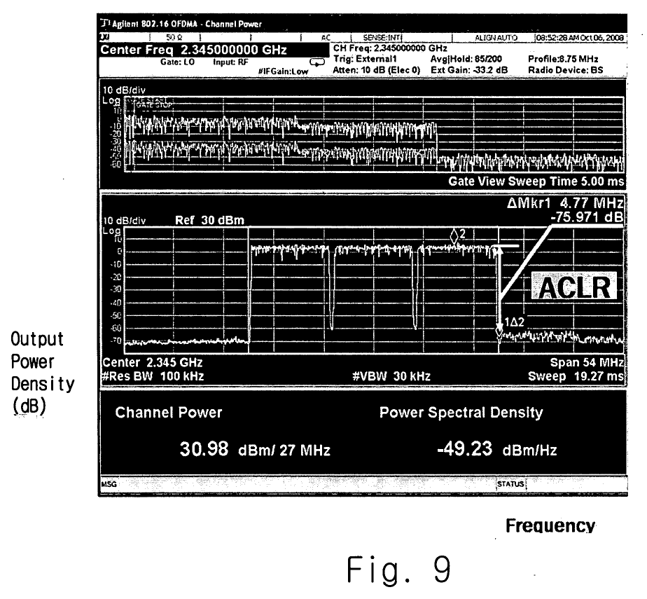

The amplification system of the present invention includes a High Gain Driving Amplifier (HGDA), Filter Module (FM), and a Linearization RF Power Amplifier (LA), as shown in FIG. 6. In order to evaluate and compare the data of the present invention shown in FIGS. 6-16 with the data presented for the prior art shown in FIGS. 1-5, the targeted output signal power was chosen when using the HGDA-FM-LA combination during experimentation was the same as the output signal power recorded for the DA-PA combination. The input RF signal to be amplified and outputted from a communications unit enters at point (a′) into the HGDA, as depicted in FIG. 6. FIG. 7 shows an example of the input RF signal at point (a′) into the HGDA, as depicted in FIG. 6. Notice that the ACLR of FIG. 3 and FIG. 7 is about the same value as −32 dB to evaluate and compare the amplification systems of FIG. 1 and FIG. 6. The HGDA is a high gain amplifier. The function of HGDA is to generate a large pre-determined gain to the input RF signal and deliver the amplified RF signal to the FM and the LA. A magnitude of gain in the range of about 60 dB to 80 dB is envisioned at the HGDA, which is much larger than that of the conventional DA depicted in FIG. 1. The gain generated in the HGDA while the HGDA is operating at or near its saturation point, in order to provide that the amplifier used as the HGDA is operating at or near optimal efficiency of the amplifier. FIG. 8 shows a first amplified version of the input RF signal of FIG. 7, which is depicted at point (b′) in FIG. 6. The HGDA is chosen based on the amplifier's output level and optimizing the amplifier's efficiency, and is less concern with its output signal quality, as shown in FIG. 8. This is because the input RF signal to the LA will be improved significantly by the FM. The FM includes one or more Band Pass Filters (BPF). The FM can also include additional components to improve the signal processing of the first amplified version of the input RF signal, as will be describe further. The one or more BPF of the FM are used to improve the first amplified version of the input RF signal to meet ACLR requirements. This is shown in FIG. 9, which shows the first amplified version of the input RF signal of FIG. 7 at point (c′) after the signal has been filtered to produce a filtered amplified version of the input RF signal of FIG. 7. The FM is setup to produce an extremely clean signal with specific properties, as shown in FIG. 9 for the LA input. This is because the LA is to be designed to operate at near its saturation point for optimum power output efficiency with the pass-in quality.

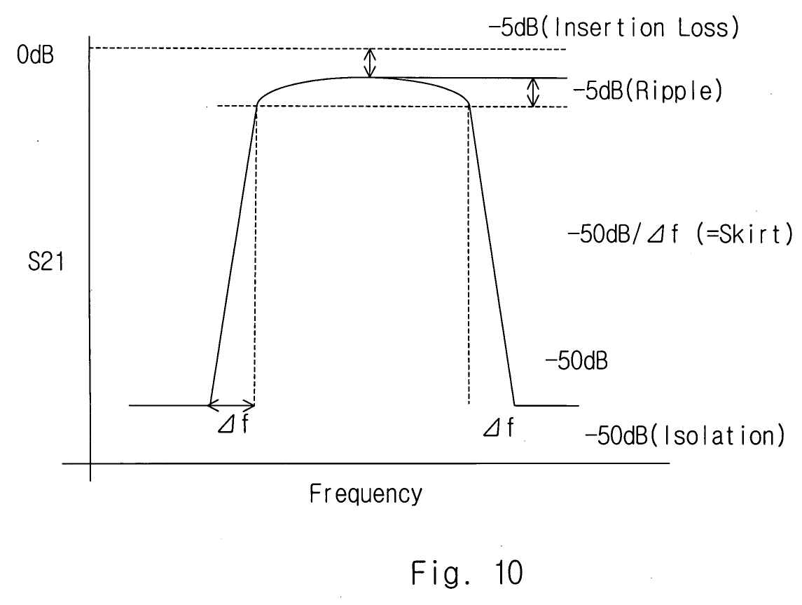

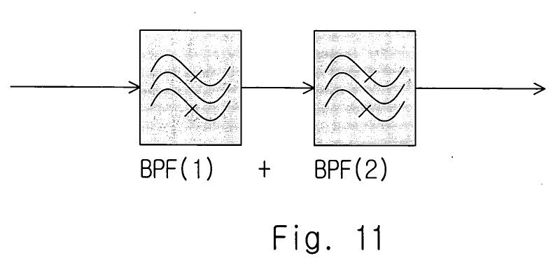

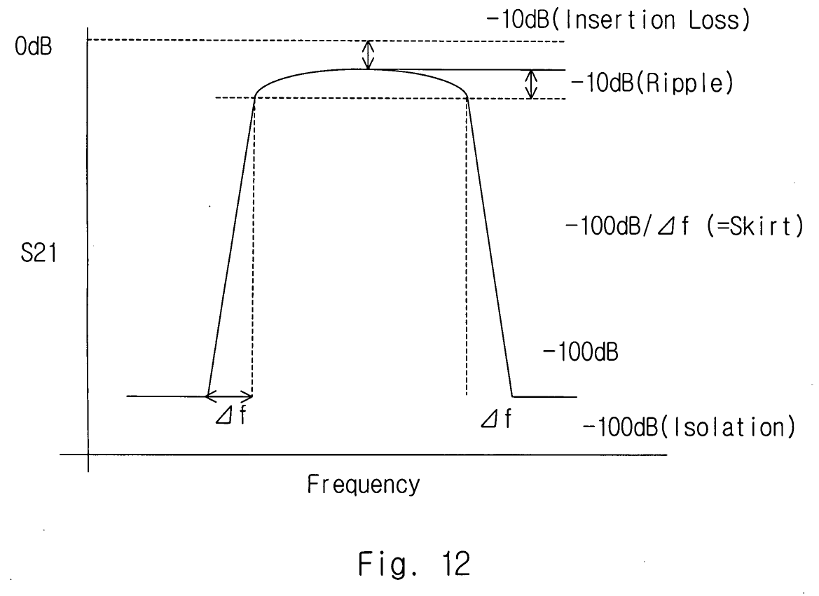

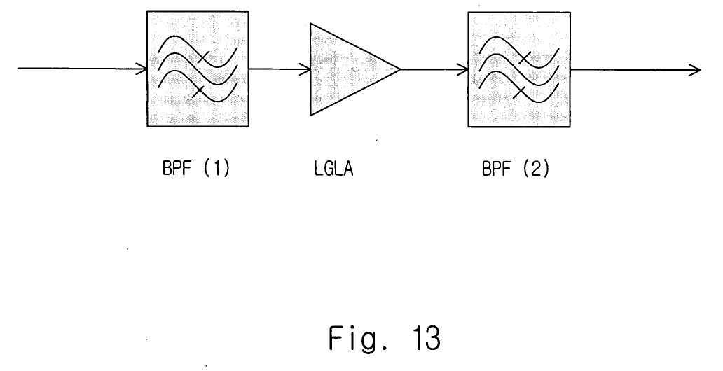

FIG. 10 depicts an example of the characteristics of a RF band pass filter (BPF). FIG. 11 is a schematic diagram of two RF band pass filters connected in series. The RF band pass filters described through out the present invention can be of various types, including a metal cavity, dielectric, strip line, elliptic function type, coaxial line, PBAR, and so on. When more than one RF band pass filter is used, there can be a combination of all above different types of RF band pass filters. FIG. 12 depicts an example of the characteristics of two RF band pass filters of FIG. 10 connected in series. Notice that the isolation and skirt properties which affect ACLR have been improved twice from −50 dB to −100 dB and from −50 dB/delta f to −100 dB/delta f, respectively. However, an insertion loss and ripple become degraded twice, from −5 dB to −10 dB and from −10 dB to −20 dB, respectively. By connecting several high quality RF band pass filters in series, the ability to obtain larger isolation and skirt values is achieved. For an example, if a number “N” of RF band pass filters is connected in series for the BPF depicted in FIGS. 10 and 11, then the final isolation and skirt values will be N×(−50 dB) and “N×(−50 dB/delta f)”, respectively. Insertion loss and ripple will also increase by “N×(−5 dB)” and “N×(−5 dB)”, respectively, for the BPF depicted in FIGS. 10 and 11. Insertion loss can be compensated for by installing a Low Gain Linear Amplifier (LGLA) between RF band pass filters, as shown in FIG. 13. The LGLA is usually a low gain linear power amplifier used to make up for signal loss during filtering of a signal.

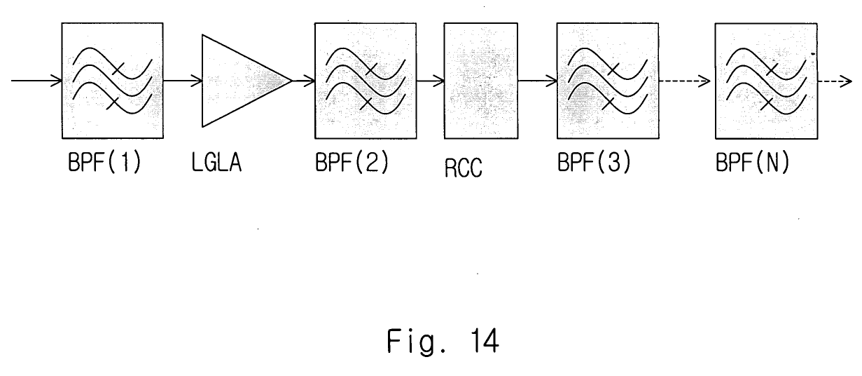

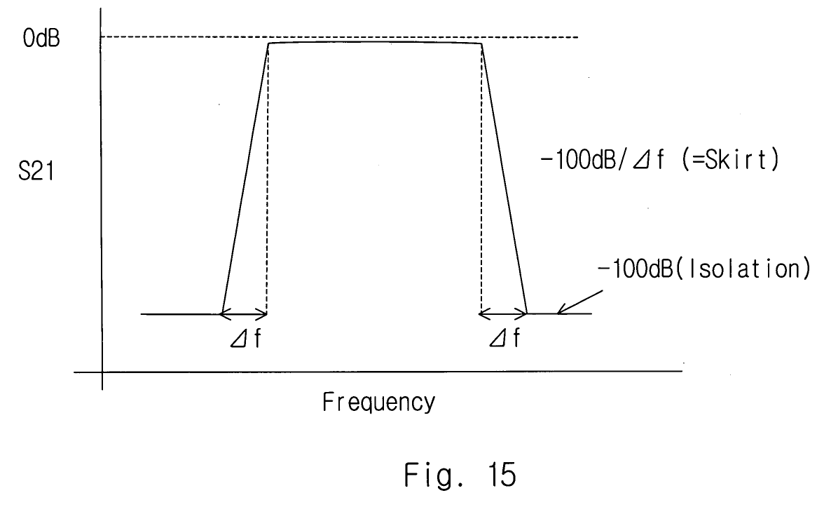

A more difficult task is the improvement of the ripple property, as the ripple property deteriorates by connecting several RF BPFs in series. Prevention of ripple property deterioration can be solved by connecting, in series, a ripple compensating circuit (RCC), as depicted in FIG. 14. The RCC can be designed by using known band stop or directional filters. FIG. 15 depicts the BPF characteristics of FIG. 10 to produce an ideal response with low ripple and insertion loss properties, after the RF signal has been processed through the LGLA, RCC and BPFs depicted in FIG. 14. Note, that close to the “ZERO” for the insertion loss and ripple in terms of absolute values, indicates the superior properties of a design combination of LGLA, RCC and BPFs to from the FM. RCCs and LGLAs are used as deem necessary by the designer of the amplification system when designing the FM for specific applications. The RCCs and LGLAs can be removed or reduced by designing or selecting RF BPFs properly. It is desirable to have a tunable impedance matching tunable circuit for coupling between each of the RCC, LGLA and RF BPF connected in series to optimize the coupling between them for the maximum output. The impedance matching tunable circuit between every two components in the FM can be important. Proper impedance matching of components in the FM reduces reflection of the signal when transitioning from one component to another component. Proper impedance matching is also important between the HGDA and FM, as well as between the FM and the LA.

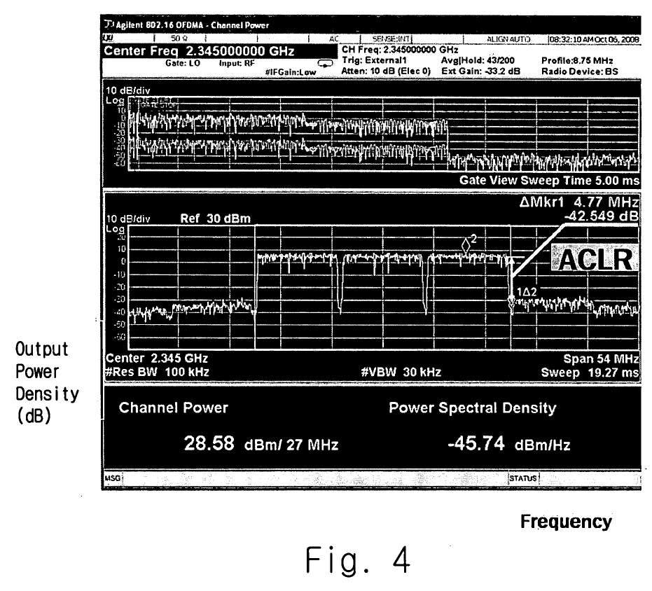

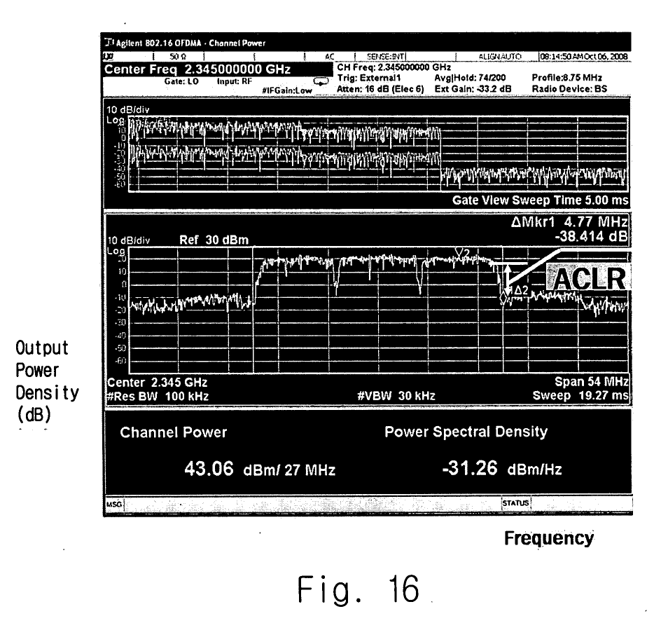

The LA is a power amplifier having a gain of not much more than 20 dB to replace the conventional PA and to produce the second amplified version of the input RF signal that will be outputted from the stationary communication unit. The LA is a low gain amplifier. The amplifier used as the LA should be is operating at or near its saturation point when producing the gain in the RF signal, in order to provide that the amplifier used as the LA is operating at or near optimal efficiency of the amplifier. FIG. 16 shows a 20 Watt second amplified version of the input RF signal of FIG. 7 at point (d′), after the LA processes the amplified version of the input RF signal of FIG. 7 from point (c′). The gain of the LA is usually chosen to be less than 15 dB. The LA is designed to operate near its saturated region to optimize an efficiency of the LA. Even though first amplified version of the input RF signal is amplified at a non-linear region of the LA with very high efficiency, the second amplified version of the input RF signal output power density spectrum looks like the signal was amplified linearly as shown in FIG. 16. The ACLR for a twenty Watt full band WIBRO output RF signal of FIG. 16 is shown to be −38 dB, which does meet the current ACLR requirement. The signal looks like the signal was amplified linearly for two reasons. First, since the gain of LA is designed to be not more than 20 dB instead of usual 30 dB to 50 dB of the conventional PA, the noise level amplified by the LA becomes at least 30 dB less than that produced by the conventional PA, thereby providing an output noise level of similar to current conventional amplification systems. Second, the quality of first amplified version of the input RF signal to the LA from FM is much better quality than that to the conventional PA, as shown by the comparison of FIGS. 4 and FIG. 9. The ACLR of FIG. 9 is about −30 dB better than that of FIG. 4.

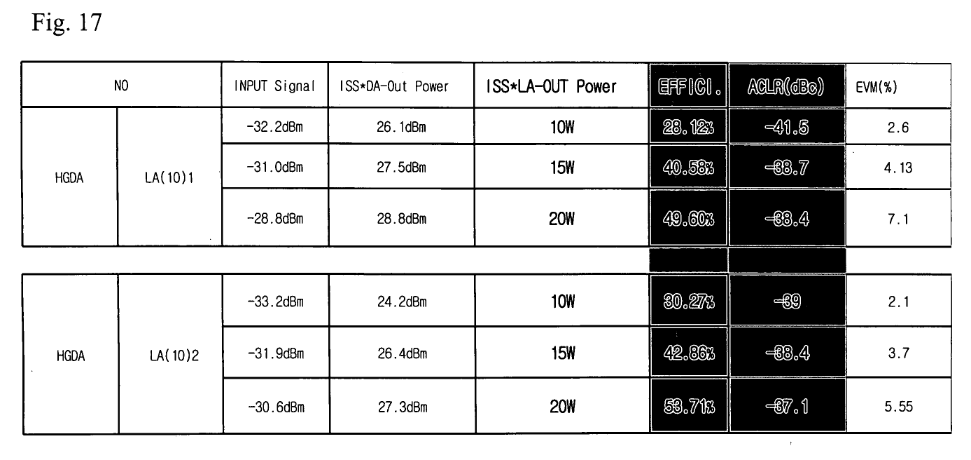

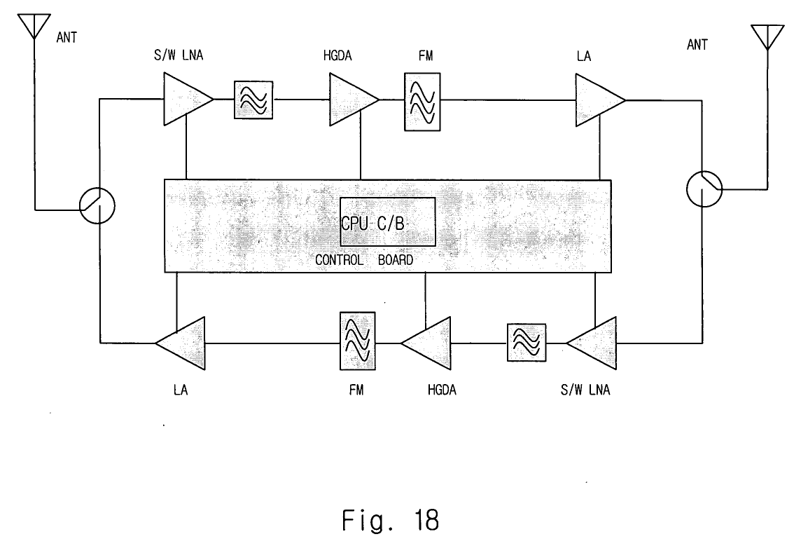

The table of FIG. 17 shows real measured data of preample power of a WIBRO full band for two different LA amplifiers. Where LA1 is a class B amplifier and LA2 is a class AB amplifier. The FM used for producing the data in the table of FIG. 17 are made of two different kinds of filters. One is a 12 poles DR cavity filter to minimize the insertion loss and the other is a 14 poles metal cavity filter for filtering out unwanted higher order harmonics. The size of FM is about 211 mm×100 mm×70 mm. The insertion loss and skirt characteristics are −3 dB and −80 dB/0.5 MHz, respectively. One well tuned impedance matching device is used between two filters. Of course the FM can be designed various ways as has been described. The table shows that for both the LA1 and LA2, the ACLR is −37 dB or better, which is acceptable for ACLR requirements. The efficiency of LA1 and LA2 using the HGDA and FM combination is better than 40% at a WIBRO full band output power level of 20 Watts. FIG. 18 shows a block diagram of a WIBRO repeater with the HGDA-FM-LA combination of FIG. 6 for providing a stationary communication unit having high RF output power efficiency. Antennas (ANT) are shown receiving and transmitting RF signals. An input RF signal from one or two ANT and amplified by an LGLA to an appropriate magnitude to supply an input RF signal to the HGDA is shown. The signal from the S/W LNA is amplified by HGDA to have a predetermined large enough gain in signal strength. This gain at the HGDA is filtered by FM to pass in-band signal and reject out-band noise sufficiently to obtain very a large isolation output signal from the FM. The signal from the FM supplies the LA with a cleaner version of the signal with the predetermined gain to provide for a desired magnitude RF output signal from the LA with satisfactory ACLR, EVM, and other required properties.

As a theoretical example, it will be explained how to determine the approximate amount of gain required at each amplifier of the HGDA-FM-LA combination. One of the variables that controls the output strength of the RF signal is gain at the LA, which has been determined to be optimal between 10 and 20 dB. If one desires an output RF signal of 100 Watt from a stationary communication unit, one would require a 50 dbm signal. One might choose an amplifier for the LA that has a 15 dB gain while operating at its saturation point. Therefore the strength of the signal from the FM should be 35 dBm, because 35 dBm plus 15 dB equals 50 dbm. It has been shown in experimentation that a properly designed FM causes a loss of −3 dB in signal strength. Therefore the signal strength should be at 38 dBm prior to entering the FM, in order to have a 35 dBm signal to enter the LA. Next, the strength of the input RF signal and the choice of the HGDA must be coordinated to produce a 38 dBm signal prior to entering the FM. As an example, the combination of an input RF signal of −32 dBm and a HGDA that generates a 70 dB gain while operating at its saturation point would produce a 38 dBm signal. The −32 dBm input RF signal is a signal that has been received and processed by the communication unit for various known reasons to be at −32 dBm. Working backwards in this manner during design produces a more precise amplification system that provides high gains while attempting to prevent self-oscillation due to parasitic feedback at the receiving antenna of the stationary communication unit.

The amplification system using the HGDA-FM-LA combination can produce gains in signal strength without sacrificing optimum power output efficiency. This because unlike the conventional systems currently in use, the two amplifiers employed are operating at or near optimal efficiency for each amplifier. The HGDA-FM-LA combination can be applied for the TDD (time division duplex) of WIBRO or mobile WIMAX, FDD (frequency division duplex) of WCDMA and again TDD of the 4^{th} generation LTE (Long Term Evolution) systems. In addition to above RF Power output efficiency enhancement by amplification system of the present invention, the HGDA-FM-LA combination also contributes on the Higher Data Rate and Spectral Efficiency, which is the efficiency of data delivery capability of the communication network. For an example, the higher spectral efficiency system requires less RF power output to cover a certain area than for lower efficiency network system. This is because the quality of RF output signal and the capability of cleaning a noisier input signal is provided by using the HGDA-FM-LA combination of the present invention.

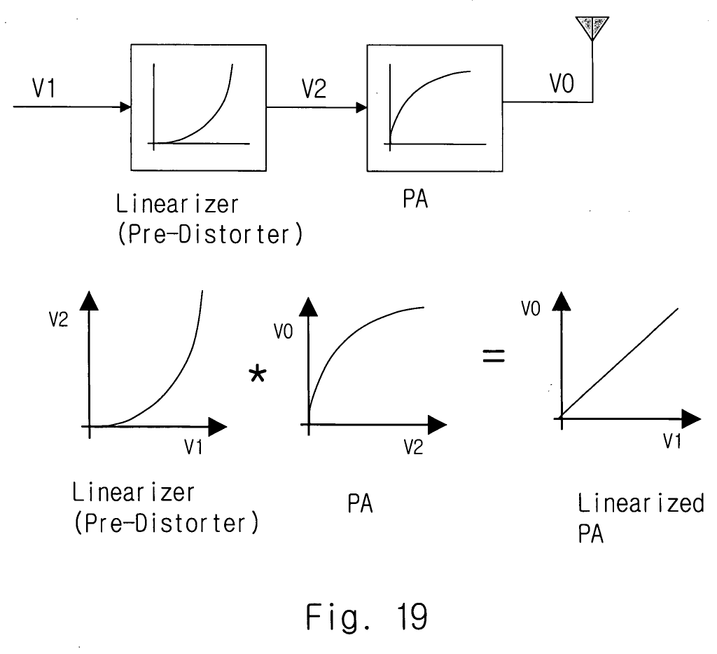

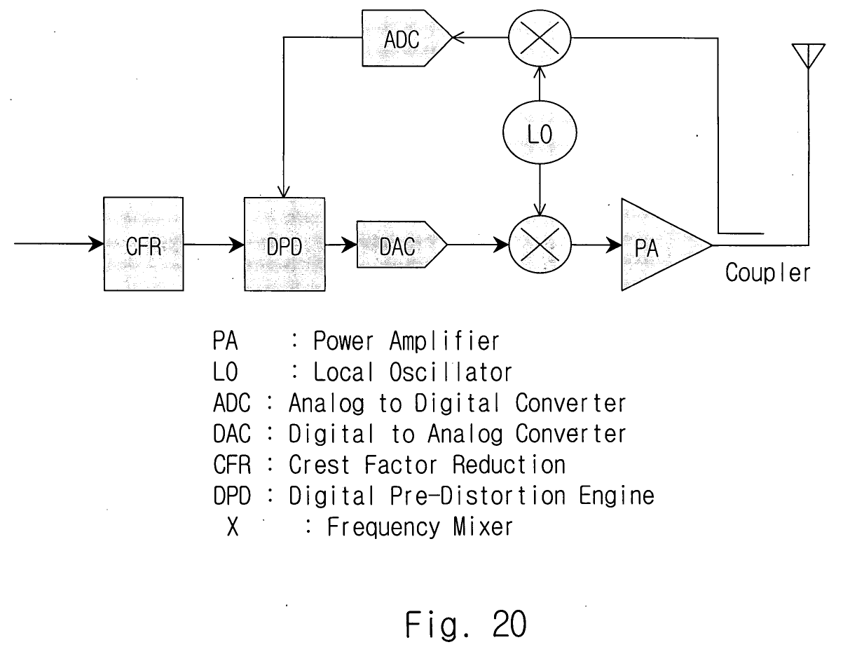

FIGS. 19 and 20 depict a known method that uses a signal processor referred to as Digital Pre-Distortion (DPD), which is used with the conventional PAs of FIG. 1. FIG. 19 shows the DPD and the components used with the DPD to aid in processing the signal to be strengthened. FIG. 20 shows the principles of the DPD technique, where combine processing of the signal with the DPD and PA in a non linear state produces an output signal that has properties as if the signal were process by an amplifier that produces gain in a linear fashion. In DPD method, the input RF signal has been converted to a digital form before entering the Crest Factor Reduction unit (CFR), so that the signal may be processed by the DPD. The input RF signal is modified due to signal processing by the DPD engine in real time using the digital form of the input RF signal and using the digitally transformed feedback of the analog output signal from the PA at a coupler in such a way as to correct or improve the ACLR of the output power density spectrum. The signal from the DPD travels through an up converter frequency mixer than to the PA, but the signal must first be converted to analog using a Digital to Analog Converter (DAC). The feedback signal from the output signal of the PA is a small percentage of the output signal from the PA. That small percentage of the output signal from the PA is converted to a digital form by traveling through a down converter frequency mixer. The down converter frequency mixer attached after the ADC is also attached to a Local Oscillator (LO) to cause the down conversion of the frequency. The down converter frequency mixer outputs the converted signal to an Analog to Digital Converter (ADC). The converted digital of the feedback signal from the PA is fed back to the DPD. Note, that in FIG. 19, there is an up converter frequency mixer between the DPD and PA that is also attached to the LO. The up converter frequency mixer along with the LO up converts the signal from the DPD after it has left the DAC. The DPD method requires a very fast micro-processor and careful adjustment of whole circuit. The DPD method has been described in detail in reference, “RF and Microwave Circuit Design for Wireless Communication”, edited by L. E. Larson, Artech House (1996), Chapter 4.

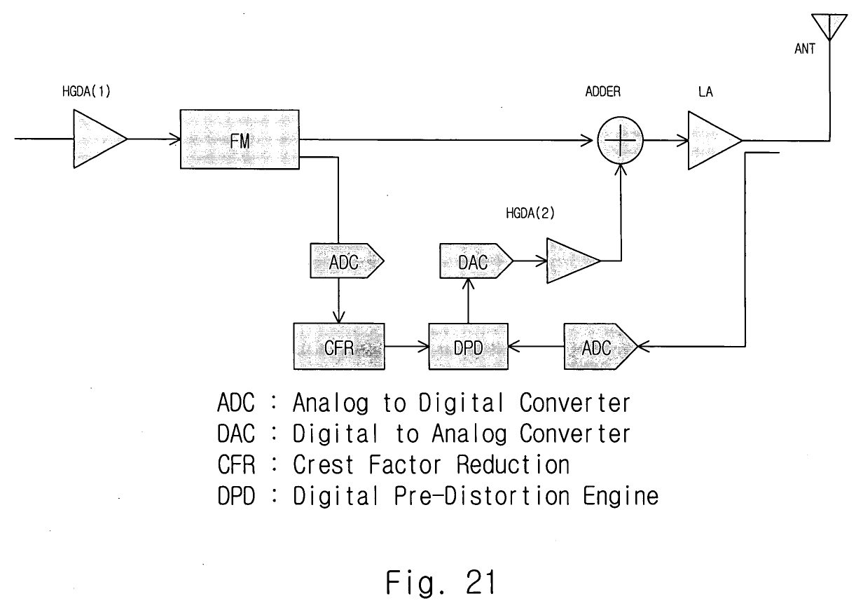

The use of the DPD method described above along with the present invention can further improve the efficiency of the output signal from the LA. FIG. 21 shows a high efficiency RF output power amplifying system incorporating both HGDA-FM-LA combination and DPD in parallel connection. Notice that the input RF signal is an analog signal from the FM and must be converted to a digital signal using the ADC before the RF signal from the FM enters the CFR of the DPD method. The output of the FM is coupled to the CFR to send part of the signal from the FM to the CFR. The signal from the FM to the CFR and DPD is a small percentage of the total signal outputted from the FM, whereby the remaining percentage of the signal is sent to LA through the Adder. The output signal from the LA is coupled to an ADC, such that a small percentage of the total signal outputted from the LA is sent to the ADC, whereby the remaining percentage of the signal is usually sent to an antenna. The signal that travels through the ADC is converted to a digital signal and is inputted to the DPD. The signals from the CFR and ADC are processed by the DPD according to known methods consistent with the DPD method. The end result of the processing by the DPD produces a modified signal that is outputted to a DAC for conversion from a digital signal to an analog signal. A second HGDA is used between the DPD and the LA. The second HGDA is used to amplify the analog signal from the DAC to be the similar strength as the signal from the FM to the Adder. The second HGDA does not necessarily have to be operated near its saturation point in the same manner as the first HGDA. Typically, the gain in signal strength is from 10 to 40 dBs at the second HGDA to achieve proper signal strength to the Adder. The Adder is a known device used to combine two or more signals to form one signal. The signal that is outputted from the Adder produces a modified signal that is sent to the LA. The result is an output signal that has further improved ACLR properties by using the DPD method with the present invention.

While different embodiment of the invention have been described in detail herein, it will be appreciated by those skilled in the art that various modification and alternatives to embodiments could be developed in light of the overall teachings of the disclosure. Accordingly, the particular arrangements are illustrated only and are not limiting as to the scope of the invention that is to be given the full breadth of any and all equivalents thereof.

I claim:

1. An amplification system adapted for efficiently amplifying signal strength of an input RF signal in wireless communications while meeting ACLR requirements, comprising:
a high gain amplifier, said high gain amplifier adapted to receive the input RF signal and process the input RF signal to produce a first amplified signal that has an increase in signal strength over the input RF signal while said high gain amplifier is operating near its saturation point;
a filter module having at least one band pass filter, said filter module adapted to receive the first amplified signal and process the first amplified signal to remove unwanted characteristics of the first amplified signal to produce a processed first amplified signal that is cleaner; and
a low gain amplifier, said low gain amplifier producing a lower gain output than said high gain amplifier, said low gain amplifier adapted to receive the processed first amplified signal and process the processed first amplified signal to produce a second amplified signal that has an increase in signal strength over the processed first amplified signal while said low gain amplifier is operating near its saturation point.

2. The amplification system of claim 1, further including a low gain linear power amplifier between at least two band pass filters in said filter module to make up for loss during filtering of the signal.

3. The amplification system of claim 1, further including a ripple compensating circuit between at least two band pass filters in said filter module.

4. The amplification system of claim 1, further including impendence matching circuits at coupling points between components of said amplification system.

5. The amplification system of claim 1, wherein said high gain amplifier has a gain in the range of 60 dB to 80 dB and wherein said low gain amplifier has a gain in the range of 5 dB to 20 dB.

6. The amplification system of claim 1, wherein said filter module includes a combination of is designed to pass in-band signal and reject out-band noise sufficiently to obtain a very larger isolation output signal from said filter module and supplied a desired magnitude RF output signal to said low gain amplifier with satisfactory ACLR properties.

7. The amplification system of claim 1, further including a digital pre-distortion processor coupled to said filter module to receive a percentage of the processed first amplified signal from said filter module, said digital pre-distortion processor connected to said low gain amplifier to receive a percentage of the second amplified signal; further including a signal adding device between said filter module and said low gain amplifier; further including a third amplifier connected between said digital pre-distortion processor and said mixing device and further including said mixing device connected to said low gain amplifier.

8. The amplification system of claim 7, further including impendence matching circuits at coupling points between components of said amplification system.

9. The amplification system of claim 7, wherein said high gain amplifier has a gain in the range of 60 dB to 80 dB and wherein said low gain amplifier has a gain in the range of 5 dB to 20 dB.

10. The amplification system of claim 7, wherein said filter module includes a combination of is designed to pass in-band signal and reject out-band noise sufficiently to obtain a very larger isolation output signal from said filter module and supplied a desired magnitude RF output signal to said low gain amplifier with satisfactory ACLR properties.

11. A method of amplifying an input RF signal in wireless communication systems at an improved efficiency while meeting ALCR requirements, comprising the steps of:
sending an input RF signal to a high gain amplifier;
processing the input RF signal in the high gain amplifier while the high gain amplifier is operating near its saturation point to produce a first amplified signal that has an increase in signal strength over the input RF signal;
outputting the first amplified signal from the high gain amplifier;
sending the first amplified signal outputted from the high gain amplifier to a filter module having at least on band pass filter;
processing the first amplified signal to remove unwanted characteristics of the first amplified signal to produce a processed first amplified signal that is cleaner;
outputting the processed first amplified signal from the filter module;
sending the processed first amplified signal outputted from the filter module to a low gain amplifier;
processing the processed first amplified signal in the low gain amplifier while the low gain amplifier is operating near its saturation point to produce a second amplified signal to be outputted, where the second amplified signal has an increase in signal strength over the input RF signal while maintaining ACLR requirements.

12. The method of claim 8, further including processing the first amplified signal by including low gain linear power amplifier between at least two band pass filters in said filter module to make up for loss during filtering of the signal.

13. The method of claim 11, further including processing the first amplified signal by including a ripple compensating circuit between at least two band pass filters in the filter module.

14. The method of claim 11, further including processing the input RF signal by including impendence matching circuits at coupling points between components of the amplification system.

15. The method of claim 11, wherein input RF signal is processed such that there is a gain in the range of 60 dB to 80 dB in the high gain amplifier and wherein the processed first amplified signal is processed such that there is a gain in the range of 5 dB to 20 dB in the low gain amplifier.

16. The method of claim 11, wherein the processed first amplified signal is processed to pass in-band signal and reject out-band noise sufficiently to obtain a very larger isolation output signal from the filter module and supplied a desired magnitude RF signal to the low gain amplifier with satisfactory ACLR properties.

17. The method of claim 11, further including sending a first percentage of the processed first amplified signal from said filter module to a digital pre-distortion processor to be processed; further including sending a percentage of the second amplified signal from the low gain amplifier to the digital pre-distortion processor to be processed with the percentage of the processed first amplified signal to produce a pre-distortion processed signal, further sending a second percentage of the processed first amplified signal from said filter module to a signal adding device between the filter module and the low gain amplifier; further sending the pre-distortion processed signal from the digital pre-distortion processor to a third amplifier connected to the digital pre-distortion processor to produce an amplified pre-distortion processed signal; further sending the amplified pre-distortion processed signal to the signal adding device to be combined with second percentage of the processed first amplified signal to produce a refined signal to the low gain amplifier; and processing the refined signal in the low gain amplifier while the low gain amplifier is operating near its saturation point to produce refined second amplified signal to be outputted, where the refined second amplified signal has an increase in signal strength over the input RF signal while maintaining ACLR requirements.

18. The method of claim 17, further including processing the input RF signal by including impendence matching circuits at coupling points between components of the amplification system.

19. The method of claim 17, wherein input RF signal is processed such that there is a gain in the range of 60 dB to 80 dB in the high gain amplifier and wherein the processed first amplified signal is processed such that there is a gain in the range of 5 dB to 20 dB in the low gain amplifier.

20. The method of claim 17, wherein the processed first amplified signal is processed to pass in-band signal and reject out-band noise sufficiently to obtain a very larger isolation output signal from the filter module and supplied a desired magnitude RF signal to the low gain amplifier with satisfactory ACLR properties.
